(19) United States
(12) Patent Application Publication
(10) Pub. No.: US 2007/0035078 A1
(43) Pub. Date: Feb. 15, 2007

(54) Post-processing apparatus

(75) Inventors: Kohji Yoshie, Sagamihara-shi (JP); Saburo Shimizu, Tokyo (JP); Riichi Hama, Tokyo (JP); Masahiro Kaneko, Tokyo (JP); Kiyoshi Hata, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/453,899

(22) Filed: Jun. 16, 2006

(30) Foreign Application Priority Data
Aug. 11, 2005 (JP) JP2005-232901
Apr. 27, 2006 (JP) JP2006-123183

(51) Int. Cl. B42B 5/00

(52) U.S. Cl. 270/58.01

(57) ABSTRACT

A post-processing apparatus capable of carrying out a plurality of post-processing operations, wherein for carrying out a post-processing operation, a tray for some other post-processing operations can also be utilized, without a special-purpose buffer tray being provided for each of the post-processing operations.

This application is based on Japanese Patent Application No. 2005-232901 filed on Aug. 11, 2005 and No. 2006-123183 filed on Apr. 27, 2006 in Japanese Patent Office, the entire content of which is hereby incorporated by reference.

### BACKGROUND OF THE INVENTION

The present invention relates to a post-processing apparatus for post-processing the sheets ejected from an image forming apparatus, particularly to a post-processing apparatus provided with a plurality of post-processing devices.

In recent years, a post-processing apparatus equipped with a plurality of post-processing devices has been introduced in the market. Such a post-processing apparatus applies a plurality of processing steps to a sheet with an image recorded thereon by an image forming apparatus such as a copying machine, printer and a multifunction apparatus containing the functions of these apparatuses. For example, such processing includes a step of binding by a stapling device, and a step of wrapping-binding wherein an adhesive is applied on one end face of the bundle of sheets, and a cover sheet is bonded onto the end face, and then a bundle of sheets is wrapped with the cover sheet.

Such a post-processing apparatus requires time to perform processing. When a plurality of copy files are to be made, the post-processing apparatus is provided with a buffer tray for temporary loading of the succeeding sheets continuously ejected from the image forming apparatus, before the processing for the next file starts. Thus, the sheets for processing for the next file can be loaded continuously into the buffer tray even when the preceding processing is being executed. This arrangement ensures high speed processing.

If a post-processing apparatus containing a plurality of such post-processing devices is provided with a stack tray and a buffer tray for each of the post-processing devices, the size of the apparatus must be increased and such a problem has been left unsolved.

To solve this problem, Patent Document 1 proposes a method wherein a buffer tray is arranged between the image forming apparatus and a post-processing apparatus, so that the apparatus need not wait for the succeeding step of image formation, and the processing capability of the image forming apparatus is not sacrificed.

The method of placing a buffer tray in-between as described in the Patent Document 1, however, is inevitably accompanied by the problems of increased apparatus size and higher costs.

[Patent Document 1] Unexamined Japanese Patent Application Publication No. 2003-89473

### SUMMARY

The present invention is the following Structures:

(1) A post-processing apparatus for post-processing a sheet ejected from an image forming apparatus used for image formation, the aforementioned post-processing apparatus including:

a plurality of post-processing devices of different types; and

a stack tray for post-processing devices to stack the sheets ejected from the aforementioned image forming apparatus, the aforementioned sheets being to be processed by any one of the post-processing devices;

wherein this stack tray for post-processing devices also serves as a buffer tray for any one of other post-processing devices.

### BRIEF DESCRIPTION OF THE DRAWINGS

FIG. 1. is a front view of a bookbinding apparatus as an embodiment of the present invention.

FIG. 2 is a diagram representing how the sheets S1 held in a vertical position by a collecting section 50 are pasted;

FIG. 3 is a diagram representing the process of coating an adhesive.

FIG. 4 is a diagram representing the traveling of a coating head.

FIG. 5 is an outline cross-sectional view diagram related to the cover sheet storing section storing the cover sheets and the cover sheet supporting section that supports the cover sheet.

FIG. 6 is a schematic perspective view of a cover sheet support section viewed in the direction A of FIG. 5.

FIG. 7 is a top view of a cover sheet support device.

FIG. 8 is a diagram representing the process of bonding a cover sheet to book structural sheets.

FIG. 9 is a diagram illustrating the processing of the cover sheet subsequent to bonding.

FIG. 10 is a partial-diagram representing a stapling device having been installed.

FIG. 11 is a diagram representing the installed position of the stapling device as viewed in the direction of arrow M.

### DETAILED DESCRIPTION OF THE PREFERRED EMBODIMENT

The following describes embodiments in the present invention. The following assertive description in the embodiments of the present invention refers to the best mode, without the terminology or technical scope being restricted thereto.

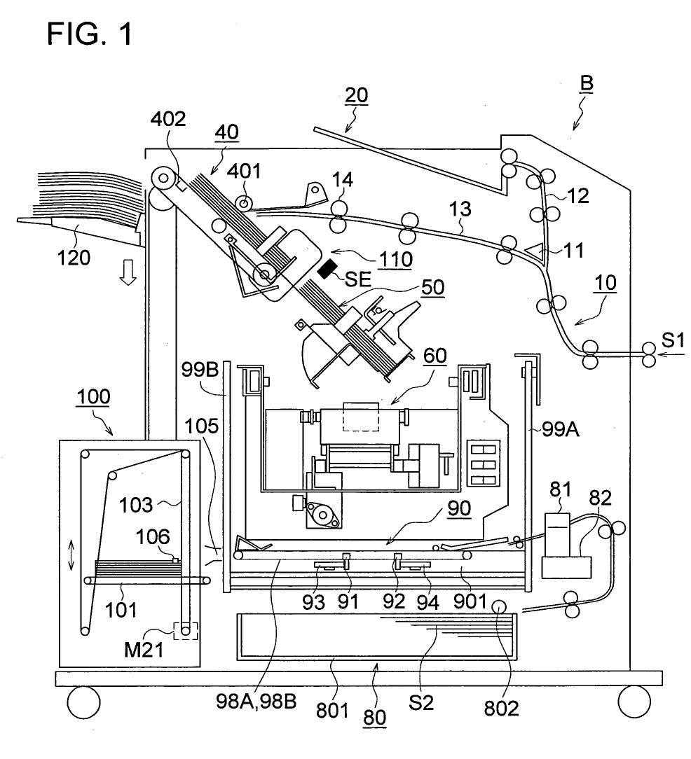

FIG. 1 is an schematic cross sectional view representing the front of a post-processing apparatus equipped with a pasting and binding device as a wrapping-binding device of the present invention and a stapling device as a stitching device.

The post-processing apparatus B includes a conveyance section 10 for conveying the sheets S1 ejected from an image forming apparatus based on electrophotographic technology, terminal line printer for computer, printing machine and others (not illustrated; hereinafter collectively referred to as “image forming apparatus”), to the sheet ejection tray 20 or sheet stacking section 40 for post-processing step, a stapling device 110 for stitching the ends of sheets, a collecting section 50 for stacking the sheets S1 fed from a sheet stacking section 40 for post-processing step one sheet at a time or a predetermined number of sheets at a time, a coating device 60, a cover sheet storage section 80 for storing the cover sheet S2, a cover sheet support section 90 for supporting the cover sheet, and an end-bound booklet storage section 120 for stacking the end-bound booklets (hereinafter referred to as “elevator tray”).

The sheets S1 ejected from the image forming apparatus is discharged to the sheet ejection tray 20 through the ejection path 12 from the switching gate 11 on the conveyance section 10, or is fed to the sheet stacking section 40 for post-processing step. The sheets S1 are ejected to the sheet ejection tray 20 when not in the bookbinding mode.

The bookbinding mode provides a function of selecting any one of a plurality of post-processing devices of the post-processing apparatus B, and can be designated from a post-processing apparatus operation system (not illustrated).

When stapling process is selected in the bookbinding mode, the sheets S1 are fed to the sheet stacking section 40 for post-processing step through a conveyance path 13. When the preset number of sheets S1 have been stacked, the sheets are stitched by the stapling device 110, and are ejected to the elevator tray 120. When the preceding bundle of sheets S1 bound together by stitching is ejected from the sheet stacking section 40 for post-processing step, the succeeding sheets S1 are sequentially fed into the sheet stacking section 40 for post-processing step.

When the pasting-binding designation has been made in the bookbinding mode, the sheet S1 is conveyed to the collecting section 50 after it is switched back in the sheet stacking section 40. In the collecting section 50, the sheets S1 are accumulated, and once the set number of sheets have been accumulated in the collecting section 50, they are gripped and rotated, and the resultant bundle of sheets made of sheets S1 is held in the approximately vertical state.

A coating device 60 applies adhesive onto the spine surface as one end face of the bundle of sheets S1 held in the vertical direction.

The bundle of sheets S1 having been book-bound by being coated with adhesive is ejected to the bound booklet storage section 100. While adhesive is applied to the preceding bundle of sheets S1 and sheets S1 are bound in the form of a book, the succeeding sheets S1 are sequentially fed to the sheet stacking section 40 for post-processing step. In this case, the succeeding sheets S1 are made to wait on the sheet stacking section 40 for post-processing step, and are accumulated on the sheet stacking section 40 for post-processing step. After that, the preceding bundle of sheets S1 having been bound is discharged from the collecting section 50. After the collecting section 50 has been arranged in a tilted position, the bundle of sheets S1 having been kept waiting temporarily is fed to the collecting section 50. After that, until the preset number has been reached, sheets S1 are immediately switched backed on the sheet stacking section 40 for post-processing step and are conveyed to the collecting section 50, without being kept to wait temporarily on the sheet stacking section 40 for post-processing step. When a preset number of sheets S1 have been stacked on the collecting section 50, the collecting section 50 is turned and the bundle of sheets S1 are kept almost in the vertical direction, similarly to the case of the preceding bookbinding step. Then one end face of a bundle of sheets is coated with adhesive by the coating device 60.

Further, when the mode is switched to the wrapping-binding process mode wherein one cover sheet is used as a front cover sheet, spine cover sheet and back cover sheet, the cover sheet S2 conveyed from the cover sheet storage section 80 is cut to a predetermined length by a cutting device 81 according to the size of the sheets S1, thickness of the bundle of sheets and the size of the cover sheet S2. After that, it is fed to the cover sheet support section 90, and is bonded to the spine surface of the bundle of sheets Si coated with adhesive. Then square spine formation processing is carried out. In the wrapping-binding mode, similarly to the case of pasting-binding mode, the succeeding sheets S1 are temporarily kept waiting on sheet stacking section 40 for the post-processing step, while pasting and binding process is applied to the preceding bundle of sheets on the collecting section 50.

The sheet stacking section 40 for post-processing step of the post-processing apparatus B having a plurality of post-processing devices performs a stack tray function for temporarily stacking the sheets S1 having been ejected from the image forming apparatus, in the sheet stacking section 40 for post-processing step, and stapling them. The sheet stacking section 40 also has a buffer tray function of temporarily stacking the succeeding sheets S1 continuously ejected during the pasting and binding operation of the preceding bundle of sheets.

The following describes the details of each component of the bookbinding apparatus:

<Pasting and Binding Device>

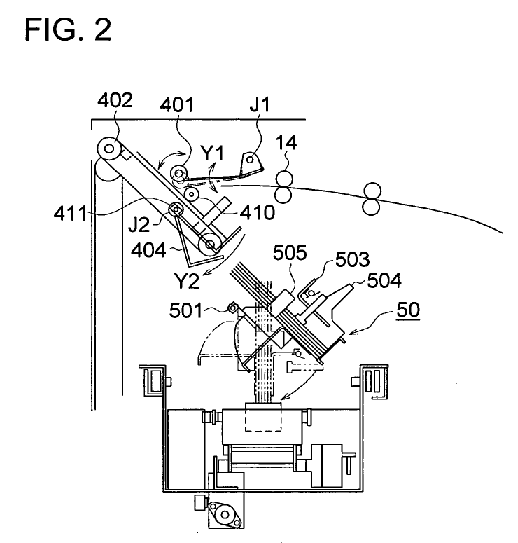

FIG. 2 is a drawing representing how the sheets S1 held in a vertical position by a collecting section 50 is pasted.

When the first booklet is bound, the sheets S1 conveyed along the conveyance path 13 is ejected by the sheet ejection roller 14, and is conveyed by the conveyance roller 401. After the sheets S1 have been raised along the tilted stacking tray 402, the conveyance roller 401 is reversed so that the sheets S1 are sequentially conveyed downward. The conveyance roller 401 can be swung around a fulcrum J1. Despite increase or decrease in the number of the stacked sheets, the conveyance roller 401 can be brought in contact with the topmost surface of the sheet to conform thereto (arrow Y1). The sheets S1 having been conveyed downward are stacked onto the collecting section 50.

A leading edge receiving plate 404 is provided to stack the sheets S1 temporarily in the sheet stacking section 40 for post-processing step in this case. When the first booklet is made, it swings around the fulcrum J2 in the direction marked by an arrow Y2 to convey the sheets S1 one by one to the collecting section 50.

As soon as the set number of sheets S1 are collected in the collecting section 50, a holding plate 503 is actuated thereby gripping and holding the bundle of sheets S1.

The part designated by the number 504 is a member for suppressing the rising-up of the accumulated sheet S1, and gets separated and again comes into contact every time a sheet S1 is fed to the collecting section 50 thereby pressing the sheet S1. The part designated by the number 505 is an alignment plate that aligns the side edges of the sheets.

With the bundle of sheet S1 in the gripped and held state, the collecting section 50 swings with the shaft 501 as the axis, and the bundle of sheet S1 is changed from the inclined state to the vertical state as shown by two-dot chain line in FIG. 2.

The following describes the sheet stacking operation for making preparation for the second booklet binding work, during the step of binding the first booklet:

To ensure that the sheets S1 for the second booklet is not fed to the collecting section 50 during the step of binding the first booklet, the leading edge receiving plate 404 swings around the fulcrum J2 in the direction opposite to the arrow Y2, and stops at a predetermined position. When a predetermined number of sheets S1 have been stacked in the stacking tray 402 and the collecting section 50 has come to the home position in an inclined form shown by the bold line in the figure, namely, when the succeeding sheet has become ready to be received after the bundle of sheets for the first booklet has been conveyed out of the collecting section 50, the leading edge receiving plate 404 swings in the direction marked by an arrow Y2. A predetermined number of sheets S1 having been stacked so far are collectively fed to the collecting section 50 by the nipping roller 410 and nipping conveyance roller 411. The rest of the sheets S1 of the bundle of sheets for the second booklets are fed one by one to the collecting section 50, without being stacked on the stacking tray 402.

<Adhesive Coating Process>

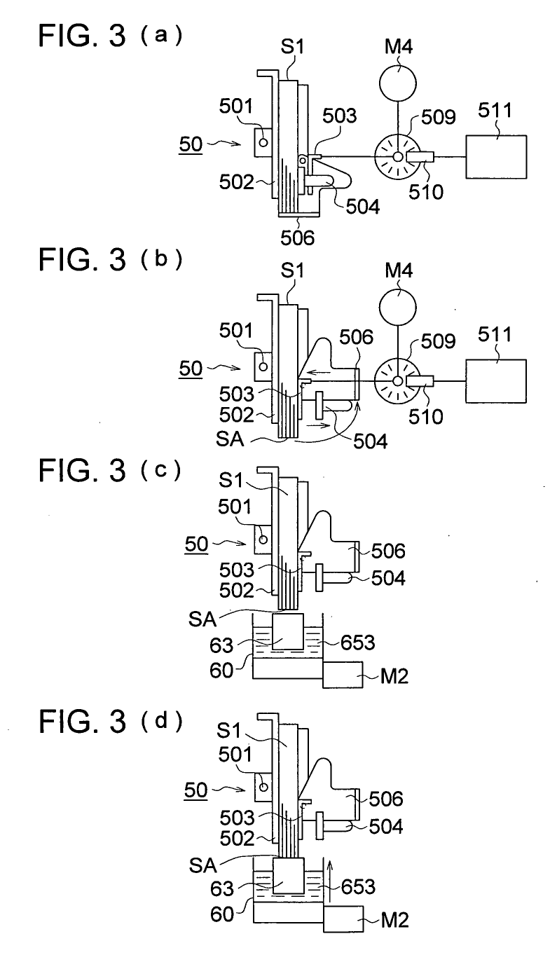

FIG. 3 shows the process of coating an adhesive to the bundle of sheets S1.

Before describing the coating process, the supporting of the sheets by the holding plate 503 in FIG. 3(a) is described below.

Before rotating the collecting section 50 to the vertical state, the holding plate 503 moves due to the drive of the motor M4, and presses the bundle of sheets S1. By stopping after detecting that the driving torque for pressing has reached a prescribed value, the bundle of sheets S1 is retained strongly by the supporting plate 502 and the holding plate 503. The stopping position of the holding plate 503 is detected by the encoder 509 and the sensor 510, and is stored in the storage device of the position detection device 511.

With the sheet bundle Sa in the retained state, the receiving plate 506 is rotated by 90 degrees thereby making it recede as shown in FIG. 3(b) while the collecting section 50 is being rotated from the inclined state to the vertical state.

In the state of FIG. 3(c), the bottom surface SA of the bundle of sheets S1 is separated from the coating roller 63.

As is shown in FIG. 3(d), the coating device 60 in which a hot melt adhesive material 653 is stored rises up, and the coating roller 63 touches the bottom surface SA of the bundle of sheets S1 in the figure. The coating roller 63 moves in a direction at right angles to the surface of the paper sheet on which FIG. 3 is illustrated, thereby coating the bottom surface of the bundle of sheets S1 with the adhesive material 653.

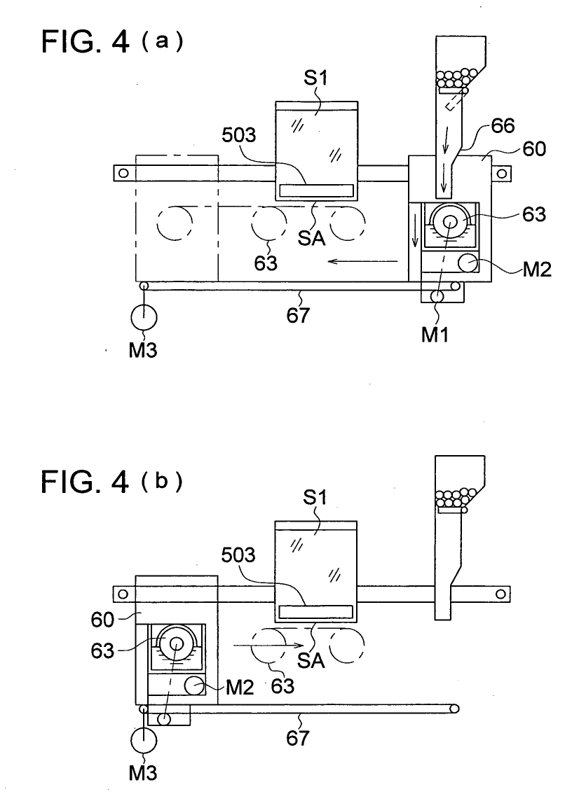

The coating process is described next referring to FIG. 4.

At the stage of starting the bookbinding in FIG. 4(a), the coating device 60 is at the right end position (the first position) which is its home position. In this home position, blocks of solid adhesive material are replenished to the coating device 60 via the replenishment path 66 and are heated to melt. At the beginning of the bookbinding process, the coating device 60 moves from the home position towards the left, and the movement from this home position to the left end position (the second position) is carried out by the drive of a belt 67 (the second moving device) which is driven by a motor M3. The movement is conducted based on the signal of the detection of the passing of the leading edge of the last of the sheets S1 constituting the bundle of sheets S1 collected in the collecting section 50, transmitted from the sheet sensor SE which is provided immediately below on the downstream side of the stacking tray 402 (see FIG. 1). While the coating device 60 is moving to the left end position, the coating roller 63 is separated from the bottom surface SA of the bundle of sheet S1.

Further in the stage of FIG. 4(b) in which the coating device 60 moves from the left end position towards the right end position, the coating roller 63 rises due to the drive of the motor M2 and comes into contact with the bottom surface SA of the bundle of sheets S1 thereby applying the adhesive material. 653. The timing of starting the coating process of FIG. 4(b) is controlled so that, when the bundle of sheet S1 has been put in the vertical state in which it can be coated, the coating is started after waiting for the transportation of the cover sheet to stop after trimming by the cutter 81. The right end position of the coating device 60 in FIG. 4 is located at the deep end when viewed from the front of the post-processing apparatus like in FIG. 1, and the left end position in FIG. 4 is the near side when viewed from the front of the apparatus.

Because of such timing control, the operations of respective parts are performed continuously and the bookbinding operation is conducted with a high efficiency. When the wrapping-binding process mode is designated, after the coating device 60 moves to the home position, the cover sheet S2 is joined to the bottom surface SA of the bundle of sheets S1.

<Joining Process>

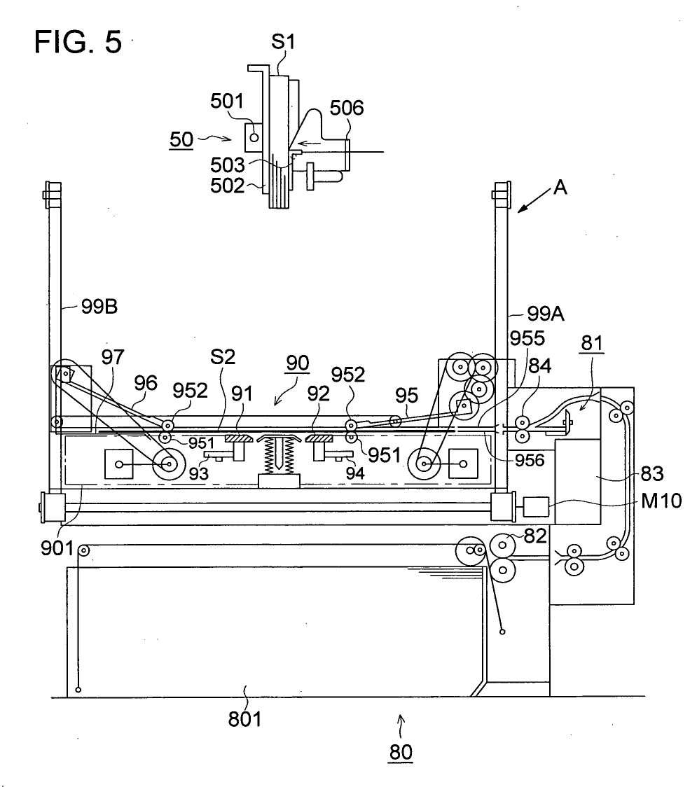

Next, the process of joining the bundle of sheets S1 and the cover sheet S2 in the wrapping-binding process mode is explained below referring to FIGS. 5-9.

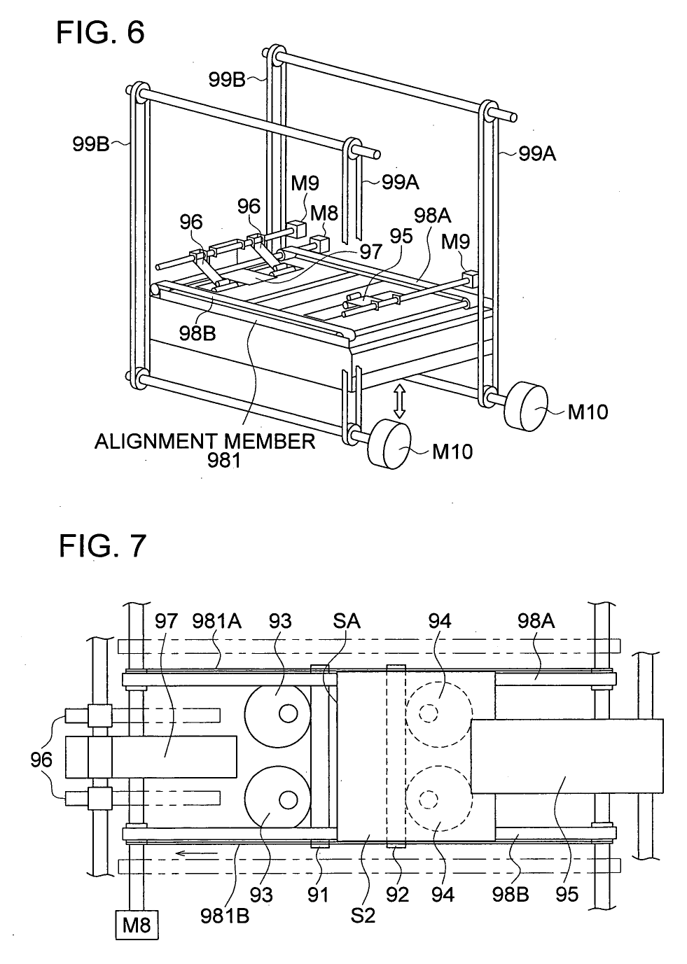

FIG. 5 is an outline cross-sectional view diagram related to a cover sheet storing section 80 storing the cover sheets S2 and the cover sheet support section 90 that supports the cover sheet. FIG. 6 is a schematic perspective view of the cover sheet support section 90 viewed in the direction A of FIG. 5.

The cover sheet S2 is stored in a sheet supply tray 801 of a cover sheet storing section 80 provided in a lower portion of the bookbinding apparatus as shown in FIG. 5. The cover sheet is fed by sheet supply conveyance rollers 82 and after being aligned and switched back in the cover sheet support section 90, is cut to a length corresponding to the bundle of sheets S1 by the cutting device 81 as a trimming device, and conveyed by the transporting rollers 84 again, and then is placed in the horizontal condition on the cover sheet support unit 901 indicated by a single-dot and dash line. The cover sheet support unit 901 is constituted using a plurality of members such as the pressing members 91 and 92, the cams 93 and 94 that drive the pressing members 91 and 92.

Further, the cutting device 81 cuts the cover sheet S2 to a length based on the information of the size of the cover sheet S2, the information of the size of sheets S1, and the information of the thickness of the bundle of sheets S1 that is stored in the position detection device 511. The cutting shreds of the cover sheet S2 after trimming are stored in the storage box 83.

The cover sheet S2 cut to a prescribed length is conveyed by transporting rollers 84 and is inserted between a top guide plate 95-5 and a bottom guide plate 956 provided with a spacing of about 5 mm. The cover sheet S2 is transported by the cover sheet transporting rollers 951 and the follower rollers 952 provided at the tips of the cover sheet pressing members 95 and 96. The cover sheet S2 is controlled so that it stops when it arrives at a prescribed position based on the size information of the cover sheet S2, and the information of the thickness of the bundle of sheets S1. A cover sheet pressing member 97 enters below the cover sheet and lifts it.

FIG. 7 is the top view diagram of the cover sheet support unit 901.

The belts 98A and 98B carry out a function of alignment operation of correcting the inclination of the cover sheet S2 that has been conveyed, and an operation of conveying the book S3 that has been bound, to the book discharging section 100.

In order to set the cover sheet S2 at a predetermined position, the aligning members. 981A and 981B are provided, that carry out alignment of both end surfaces of the cover sheet S2 in directions parallel to the direction of transportation, and belts 98A and 98B and drum-shaped rollers to extend the belts 98A and 98B are provided on the aligning members 981A and 981B and the belts 98A and 98B are movable along the both end surfaces of the cover sheet. The aligning members 981A and 981B carry out the aligning operation every time a cover sheet S2 is supplied. When the alignment operation is conducted, both sides of the cover sheet S2 enter clearances below the belts 98A and 98B and the cover sheet S2 is aligned by the aligning members 981A and 981B. In addition, when the cover sheet support unit 901 to be described later rises, the aligning members 981A and 981B and the belts 98A and 98B recede to the position shown by two-dots and one dash line in FIG. 6(a) and belts 98A and 98B are receded from above the cover sheet S2.

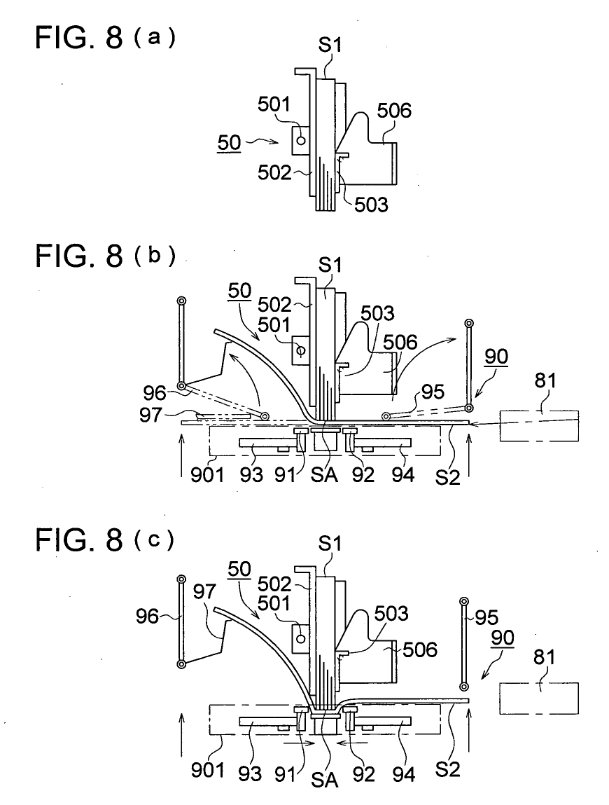

FIG. 8 is a diagram showing the cover sheet S2 pressed by pressing members 95 and 96, and being raised in that state along with the cover sheet support unit 901 due to the motor M1 that drives the belts 99A and 99B (the first moving device).

FIG. 8(a) shows that the adhesive 653 has been coated. In FIG. 8(a), the cover sheet support unit 901 supports the cover sheet S2 at a lower position away from the bottom surface of the bundle of sheets S1, as shown in FIG. 5.

When the cover sheet support unit 901 has started to rise, the cover sheet pressing members 95 and 96 holds the cover sheet S2 from above so that the cover sheet S2 is held in a plane state. Before the cover sheet S2 has risen to contact the surface SA of the bundle of sheets S1, engagement with the cover sheet pressing members 95, 96 and 97 is released by a motor M9 (FIG. 6). The resulting state is as shown in FIG. 8(b). In this case, the cover sheet S2 is raised by the cover sheet pressing member 97 placed under the cover sheet S2.

The cover sheet support unit 901 rises further by a few millimeters from the position shown in FIG. 8(b). This position after rising by a few millimeters is the position shown in FIG. 8(c). After rising, the pressing members 91 and 92 press the cover sheet S2 from left and right, make corners at the boundary between the front cover sheet and the spine cover of the book, and at the boundary between the spine cover and the back cover sheet, and the book S3 is formed by closely contacting the cover sheet S2 with the bundle of sheets S1. The duration for which the pressing members 91 and 92 are pressing is about 5 seconds, and the pressing force is about 200 Nf.

Further, the movement in the lateral direction of the pressing members 91 and 92 is obtained from the cams 93 and 94 (see FIG. 7) that are driven by motors (not shown in the figure). In addition, the device for the movement of the pressing members 91 and 92 can also have a configuration in which a rack is provided for each member, so that the member can be moved by the rotation of a pinion that engages with the rack.

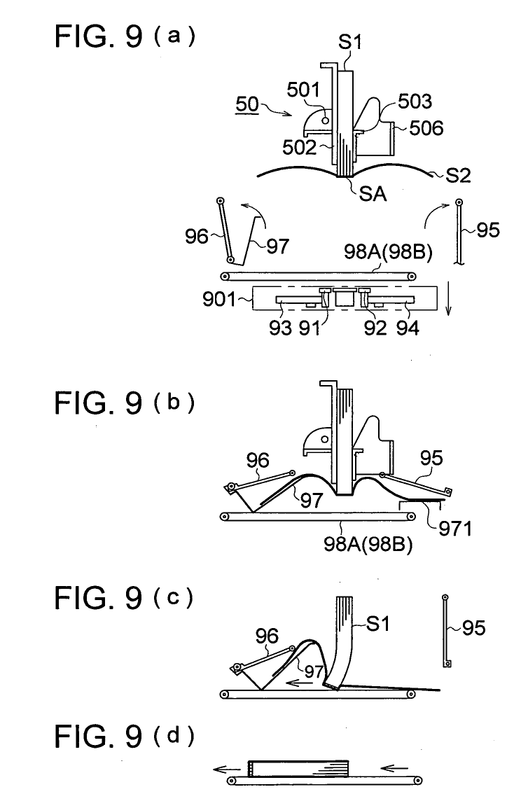

The processing of the cover sheet S2 after it has been joined is explained below using FIG. 9.

When the joining of the cover sheet S2 has been completed, the cover sheet support unit 901 that released the pressing members 91 and 92, lowers by about 100 mm due to the drive of the belts 99A and 99B and returns to the home position.

At this time, in order to lift up the left and right sides of cover sheet S2 by about 50 mm, the cover sheet pressing members 95, 96, and 97 once go to the horizontal state from the vertical state, and again swing in the opposite direction and then a cover sheet lifting member 971 is raised as shown in FIG. 9(b).

Next, the belts 98A and 98B are moved so as to return to the positions being narrower than the width of the cover sheet S2, and the cover sheet support unit 901 is raised by about 70 mm.

The holding plate 503 moves to the retracted position, so that the holding pressure is released. Because of this, the book S3 made up of the bundle of sheets S1 and the cover sheet S2 falls on the belts 98A and 98B. While the cover sheet support unit 901 is being lowered again, the belts 98A and 98B are rotated by the drive of motor M8 (see FIG. 6) and the book S3 is conveyed toward the book discharging section 100 while being tumbled. At this time, the cover sheet pressing members 96 and 97 are swung toward the upward direction, and the left side cover sheet is lifted up as is shown in FIG. 9(c). The book S3 is conveyed up to the left end by the belts 98A and 98B and is discharged, as it is, to the book discharging section 100 when the cover sheet support unit 901 arrives at its home position (FIG. 9(d)).

To ensure that the position of the ejection port 105 and the top position of the booklets stacked in the bound booklet storage section 100 is located approximately at the same level independently of the number of the booklets, the bound booklet storage section 100 is provided with a position sensor 106 and a motor M21 for causing vertical movement of the sheet ejection stand 101 on which the sheets S3 are placed, wherein the position sensor 106 is located below the ejection port 105. The height is adjusted by the drive belt 103 synchronized with the motor M21 in response to the signal from the position sensor 106.

The position sensor 106 is an optical position sensor made of a light emitting device and light receiving device. If the light path is interrupted, the position sensor 106 issues an ON signal or OFF signal, thereby performing sensing operation. The light emitting device and light receiving device are provided separately.

In the case of pasting-binding operation without bonding the cover sheet, the coating device 60 retracts to the home position on the right end shown in FIG. 4, upon completion of the process shown in FIG. 3. Then the booklet S4 drops onto the belts 98A and 98B.

The booklet S4 having dropped is conveyed by the belts 98A and 98B, and is ejected into the bound booklet storage section 100 shown in FIG. 1.

<Stapling Device>

The following describes the stapling device:

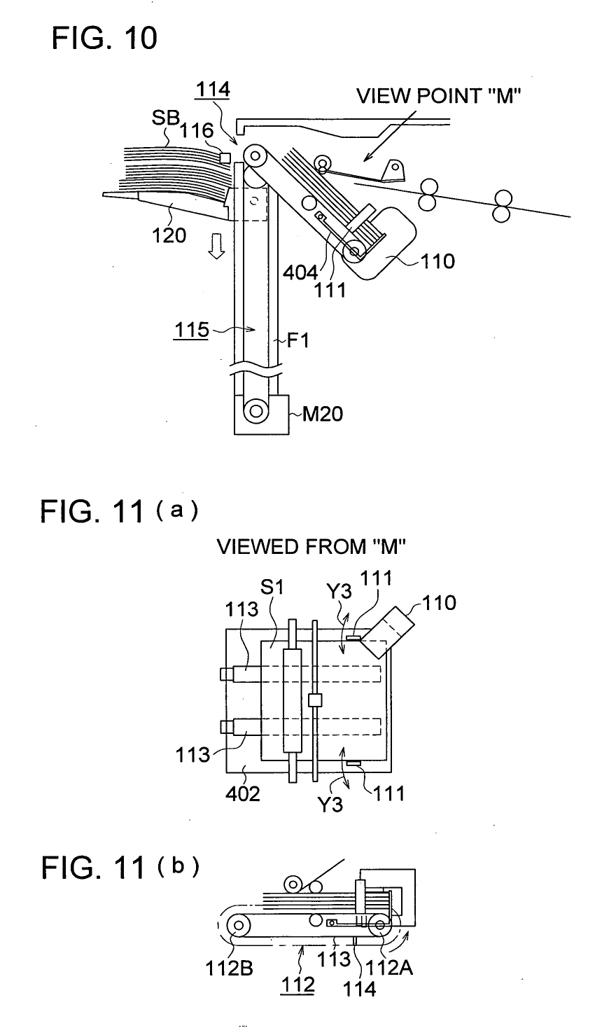

FIG. 10 is a cross sectional view showing that the sheets S1 are stacked on the sheet stacking section 40 for post-processing step by the leading edge receiving plate 404. FIG. 11(a) shows a view from the direction M in FIG. 10 and FIG. 11(b) shows the side view. The stapling device 110 is located where the staple SP is stapled at one position close to the corner of the sheets S1.

The reference numeral 111 denotes a pair of widthwise alignment members arranged movably on each side of the stacking tray 402. The alignment members 111 can be moved in the direction orthogonal to the direction of sheet conveyance. When the sheets S1 are conveyed to the stacking tray 402 and are received, the alignment members are opened wider than the sheets. When the sheets are conveyed on the stacking tray 402 and are stopped by coming into contact with the leading edge receiving plate 404, the side edges of the sheets S1 across the width are tapped, whereby a bundle of sheets are subjected to widthwise alignment (arrow Y3). At this stop position, a predetermined number of sheets S1 are stacked on the stacking tray 402 and are aligned. Then binding operation is performed by the stapling device 110 whereby the bundle of sheets S1 is bound together.

The bundle of sheets having been stapled (referred to as “booklet SB”) are driven by the conveyance section 112 located on the lower surface of the stacking tray 402, and are fed to the elevator tray 120. As shown in FIG. 11(a), the conveyance section 112 has an opening formed on part of the sheet stacking surface of the stacking tray 402 in such a way that a plurality of ejection belt 113 wound around the driving pulleys 112A and driven pulleys 112B are fitted to the opening. Further, an ejection claw 114 is integrally formed on part of the ejection belt 113, and the tip thereof forms an oblong locus, as shown by the one-dot chain line. The conveyance section 112 receives a signal from the control device, notifying termination of binding operation. After that, the driving shaft equipped with a driving pulley 112A starts rotation, and the ejection claw 114 formed integrally with the ejection belt 113 pushes out the trailing edge of the booklet SB, whereby the booklet SB is ejected to the elevator tray 120.

The reference numeral 115 is a stacked booklet height adjustment device that keeps the distance between the top face of the stacked booklets SB and ejection port 114 approximately constant in order to ensure that the booklet SB ejected to the elevator tray 120 can be stacked in an aligned form.

As shown in FIG. 10, the stacked booklet height adjustment device 115 is provided with a position sensor 116 arranged outside the ejection port 114, and a height adjustment control device (not illustrated) capable of adjusting the height position of the elevator tray 120 in response to the signal of the position sensor 116.

The position sensor 116 is an optical position sensor made up of a light emitting device and a light receiving device. It is a sensing device emitting an ON signal or OFF signal when the optical path has been cut off.

The height adjustment control device provides control so that when the booklet SB has been ejected to a position higher than the position sensor (so as to cut off the light path), the sensor signal is turned off, and the elevator tray 120 start to be lowered. When the light path has been turned on, the elevator tray 120 is stopped.

The position sensor 116 can be any of the following devices such as a separation type optical switch wherein the light emitting device is separated from the light receiving device; a reflection type switch wherein the light emitting device is located on the same plane as the light receiving device; and a mechanical switch wherein the switching operation is performed by the actuator coming into contact with the booklet SB.

The stacked booklet height adjustment device 115 includes the frame F1, a driving shaft driven by the motor M 20, a driven shaft, and a belt or a drive wire wound around a driving pulley connected to the driving shaft and a driven pulley connected to the driven shaft. The height is adjusted by rotating the motor M20 or stopping the rotation based on the instruction of the control device (not illustrated) in response to signals issued from the position sensor 116.

The present invention provides a post-processing apparatus equipped with a plurality of post-processing devices, wherein a stack tray for a post-processing apparatus to stack the sheets ejected from an image forming apparatus also serves as a buffer tray for other post-processing devices, thereby ensuring apparatus downsizing and cost reduction.

What is claimed is:

1. A post-processing apparatus for post-processing a sheet ejected from an image forming apparatus used for image formation, the post-processing apparatus comprising:
a plurality of post-processing devices of different types; and
a stack tray for post-processing devices to stack a sheet ejected from the image forming apparatus, the sheet being to be processed by any one of the plurality of post-processing devices;
wherein the stack tray for post-processing devices also serves as a buffer tray for any other one of the plurality of post-processing devices.

2. The post-processing apparatus of claim 1,
wherein while a preceding bundle of sheets is post-processed by the any other one of the plurality of post-processing devices, succeeding sheets are temporarily stacked in the stack tray, and after completion of post-processing of the preceding bundle of sheets, the succeeding sheets having been temporarily stacked on the stack tray are fed to a processing position of the any other one of the plurality of post-processing devices.

3. The post-processing apparatus of claim 1,
wherein the plurality of the post-processing devices comprise:
a stitching device for binding a bundle of sheets with a staple;
a wrapping-binding device wherein adhesive is applied to one end face of a bundle of the sheets, and the face coated with the adhesive is bonded with a cover sheet to be wrapped around the bundle of sheets.

4. The post-processing apparatus of claim 3, further comprising:
a bound booklet storage section for storing the booklets bound by the wrapping-binding device; and
a stitched booklet storage section for storing the booklets bound by the stitching device.

5. The post-processing apparatus of claim 4, further comprising:
a control device for controlling such that a top position of stacked booklets in the stitched booklet storage section is approximately constant, independently of number of the booklets.

6. The post-processing apparatus of claim 4, further comprising:
a control device for controlling such that a top position of stacked booklets in the bound booklet storage section is approximately constant, independently of number of the booklets.
